(19) United States
(12) Patent Application Publication
(10) Pub. No.: US 2025/0314874 A1
(43) Pub. Date: Oct. 9, 2025

(54) ACTUATOR FOR REFLECTOR

(71) Applicant: JAHWA electronics Co., Ltd., Chungcheongbuk-do (KR)

(72) Inventor: IN CHEOL HONG, Chungcheongbuk-do (KR)

(21) Appl. No.: 19/098,049

(22) Filed: Apr. 2, 2025

(30) Foreign Application Priority Data
Apr. 8, 2024 (KR) 10-2024-0047330

(51) Int. Cl. G02B 26/08; G02B 7/182; H04N 23/68

(52) U.S. Cl. CPC G02B 26/0816; G02B 7/1821; H04N 23/687

(57) ABSTRACT

An actuator for a reflector according to an embodiment includes a carrier at which a reflector is installed and configured to rotate in a first direction, a middle guide at which a second magnet is installed and configured to support rotation of the carrier, a first ball disposed between the carrier and the middle guide, a first magnet installed on the carrier; and a first coil configured to provide a driving force to the first magnet. Neighboring magnetic poles of the first and second magnets are made of the same magnetic pole so that a repulsive force acts between the first and second magnets.

### CROSS-REFERENCE TO RELATED APPLICATION AND CLAIM OF PRIORITY

This application claims the benefit under 35 USC § 119 of Korean Patent Application No. 10-2024-0047330 filed on Apr. 8, 2024, in the Korean Intellectual Property Office, the entire disclosure of which is incorporated herein by reference for all purposes.

### BACKGROUND

### 1. Technical Field

The present disclosure relates to an actuator for a reflector, and more specifically, to an actuator for a reflector that improves the arrangement structure of magnetic poles to enhance driving precision.

### 2. Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

An optical image stabilization (OIS) function means a function of improving the sharpness of an image by adaptively moving the carrier having a lens in a direction to compensate for the shaking when the lens is shaken due to trembling.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

Recently, mobile terminals are equipped with zoom or the like lenses with specifications such as the ability to variably adjust the focal length or capture images from a distance in order to meet ever-increasing user needs and implement more diverse user convenience.

The zoom lenses have a structure in which a plurality of lenses or lens groups are arranged side by side or the lens itself has a long length in the optical axis direction, so a larger mounting space must be provided in the mobile terminal.

Recently, in order to organically combine the physical characteristics of the zoom lens with the geometrical characteristics of the mobile terminal, an actuator or camera module with a physical structure that refracts the light of the subject using a reflector placed at the front of the lens has been disclosed.

The actuator or the like that employs a reflector implements OIS by moving the reflector, which reflects the light of the subject toward the lens, along one or two axes, when shaking occurs.

When OIS is performed in two axial directions, the moving bodies in each direction are configured to rotate independently, so a magnet is installed for each moving body to drive this independent rotation.

In the case of a device or actuator employing a reflector, unlike a traditional OIS that implements OIS through linear movement, OIS is implemented through the rotation of the reflector, so the relative position or posture relationship between moving bodies changes dynamically.

Therefore, the influence of the magnetic force between the magnets equipped in each moving body also has nonlinear characteristics depending on the relative positional relationship between the moving bodies.

When the magnetic force between magnets has nonlinear characteristics, the precision of OIS operation in each direction is reduced, and it is also impossible to implement the function (centering) in which the moving body returns to a set reference position or initial position (default position) after OIS is terminated. In this regard, in the case of a conventional actuator, when OIS operation is initiated, processing to determine the current position of the reflector must be performed in advance, so the immediate responsiveness deteriorates and the driving precision also decreases.

### SUMMARY

The present disclosure is designed to solve the problems of the related art, and therefore the present disclosure is directed to providing an actuator for a reflector, which may effectively implement a return force for a moving body to return to a specific reference position and increase the driving precision of OIS by improving the magnetic pole arrangement of magnets provided to each moving body so that a repulsive force is applied between the magnetic poles that become relatively close due to rotational movement.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

An actuator for a reflector according to an embodiment of the present disclosure may include a carrier at which a reflector is installed, the carrier being configured to rotate in a first direction; a middle guide at which a second magnet is installed, the middle guide being configured to support rotation of the carrier; a first ball disposed between the carrier and the middle guide; a first magnet installed on the carrier; and a first coil configured to provide a driving force to the first magnet.

In this case, neighboring magnetic poles of the first and second magnets are made of the same magnetic pole so that a repulsive force acts between the first and second magnets.

The actuator for a reflector according to the present disclosure may further include a housing configured to support rotation of the middle guide in a second direction; a second ball disposed between the middle guide and the housing; and a second coil configured to provide a driving force to the second magnet.

In addition, the first magnet according to the present disclosure may include a first sub-magnet provided at one side of the carrier; and a second sub-magnet provided at the other side of the carrier and configured to rotate in the same direction as the first sub-magnet when the carrier rotates in the first direction. In this case, when the carrier rotates in the first direction, a magnetic pole of the first sub-magnet close to the second magnet may be opposite to a magnetic pole of the second sub-magnet close to the second magnet.

Preferably, the actuator for a reflector according to the present disclosure may further include a magnetic body installed on the carrier and configured to generate an attractive force with the second magnet.

Here, the magnetic body of the present disclosure may be a magnet facing the second magnet, and a facing magnetic pole of the magnetic body facing the second magnet may be opposite to a magnetic pole of the second magnet.

Preferably, the magnetic body may have a shape extending in a direction corresponding to a longitudinal direction of the second magnet. Also, the magnetic body may be configured to have an outer width greater than an inner width.

According to a preferred embodiment of the present disclosure, by causing a repulsive force to be applied between magnets that become relatively close to each other by rotational movement, the nonlinear behavior characteristics of the magnetic field between the magnets may be improved, thereby improving the driving precision of the OIS.

In addition, in an embodiment of the present disclosure, by symmetrically installing a plurality of magnets on a moving body with respect to a center of rotation and causing all of the magnets to exert a repulsive force in the same direction in relation to the magnets installed on the relative stator, the stability and precision of the rotational movement may be improved.

According to a preferred embodiment of the present disclosure, by generating an attractive force between a moving body and a stator through a mutually corresponding magnetic pole relationship, the adhesion between the moving body and the stator and the return force of the moving body to a reference position may be implemented simultaneously.

Also, in a preferred embodiment of the present disclosure, the torque for returning to the original position may be more effectively generated without reducing the suction force through the physical shape of the magnetic body having an outer width relatively larger than the inner width.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1 and 2 are diagrams showing the overall configuration of an actuator for a reflector and a camera module according to a preferred embodiment of the present disclosure,

FIGS. 3 and 4 are exploded views showing the detailed configuration of the actuator for a reflector according to a preferred embodiment of the present disclosure,

FIG. 5 is a diagram for illustrating the operational relationship in which the reflector rotates in a first direction,

FIG. 6 is a diagram for illustrating the operational relationship in which the reflector rotates in a second direction,

FIG. 7 is a drawing for illustrating the arrangement relationship of individual magnets,

FIGS. 8A to 8C are drawings for illustrating the positional relationship of magnets according to the rotation of the carrier,

FIG. 9 is a drawing for illustrating the operational relationship of a pulling magnet according to an embodiment of the present disclosure, and

FIG. 10 is a drawing for illustrating the operational relationship of a pulling magnet according to another embodiment of the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

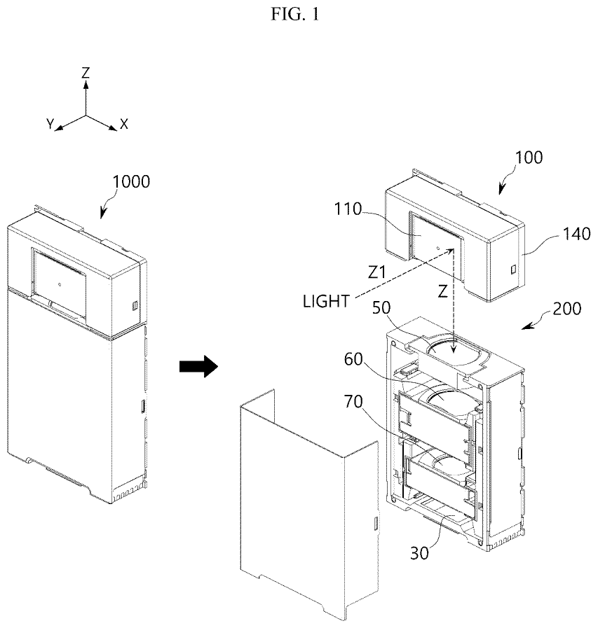

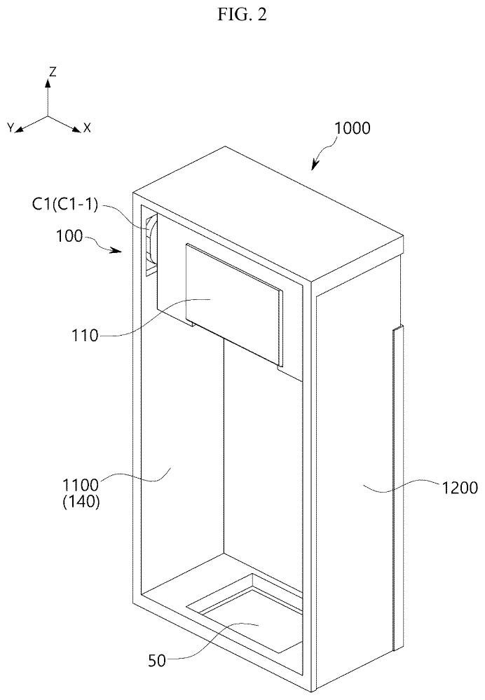

FIGS. 1 and 2 are diagrams showing the overall configuration of an actuator 100 for a reflector (hereinafter, referred to as an ‘actuator’) and a camera module 1000 according to a preferred embodiment of the present disclosure.

The actuator 100 of the present disclosure may be implemented as a single device, and as shown in FIG. 1, may be implemented in the form of a camera module 1000 including at least one lens 50, 60, 70, a lens driving module 200 for implementing zoom and/or autofocus (AF), or the like, and an image sensor 30.

In the actuator 100 of the present disclosure, the light of a subject does not flow directly into the lens 50, 60, 70, but the actuator 100 is configured such that the light of a subject flows into the lens 50, 60, 70 after changing (refracting, reflecting, or the like) the path of light through a reflector 110 provided in the actuator 100 of the present disclosure.

As illustrated in FIG. 1, the path of light coming from the outside is Z1, and the path of light coming from the outside and flowing into the lens 50, 60, 70 after being refracted or reflected by the reflector 110 is Z.

In the following description, Z-axis direction corresponding to the direction in which light flows into the lens 50, 60, 70 is referred to as an optical axis or an optical axis direction, and two directions perpendicular to the Z-axis direction are referred to as X-axis and Y-axis.

In the drawing, the Y-axis is shown as a direction axis toward a subject from the reflector 110 as an example, but it is also possible to define the X-axis as a direction axis toward the subject from another relative perspective.

Based on the optical axis direction, an image sensor 30 such as CCD or CMOS that converts light signals into electrical signals may be provided at the rear end of the lens 50, 60, 70, and a filter that blocks or transmits light signals in a specific band may be provided together. Of course, the number and location of lenses 50, 60, 70 may be different from those shown in the drawings depending on the embodiment.

As will be described in detail later, the actuator 100 of the present disclosure corresponds to a device that implements OIS for the X-axis direction or/and Y-axis direction by rotating the reflector 110 in a direction that compensates for the movement when shaking due to hand tremor occurs based on the X-axis direction and/or Y-axis direction perpendicular to the optical axis.

As illustrated in FIG. 1, the actuator 100 of the present disclosure may be implemented as an independent device and combined with other devices constituting the camera module 1000, and may also be implemented in various forms, such as being included inside a housing 1100 of the camera module 1000 as illustrated in FIG. 2 or the like.

In this case, a housing 140, which is a component of the actuator 100, may be the housing of the actuator 100 itself or the housing 1100 of the camera module 1000.

The axes shown in the drawings, terms referring to the axes, and terms such as “upper”, “lower”, “front”, “rear”, “vertical”, “horizontal”, or the like described with respect to the axes are intended to present a relative standard for describing an embodiment of the present disclosure, and it is obvious that these terms are not intended to specify any direction or location on an absolute basis. Of course, these terms may vary relatively depending on the location of a target object, the position or direction of view, or the like.

In the following description, an embodiment of the present disclosure will be described with the Z-axis as a standard for the upper and lower direction or the vertical direction, and from a corresponding perspective, an embodiment of the present disclosure will be described with the Y-axis as a standard for the front or rear direction and the X-axis as a standard for the left or right direction.

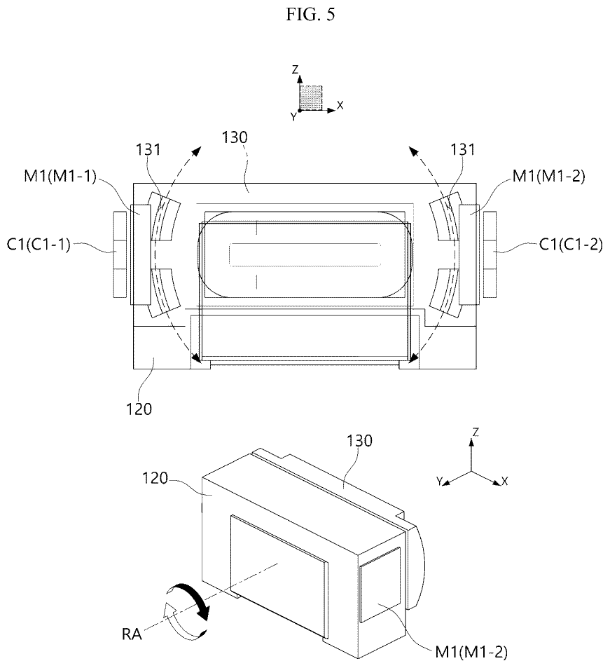

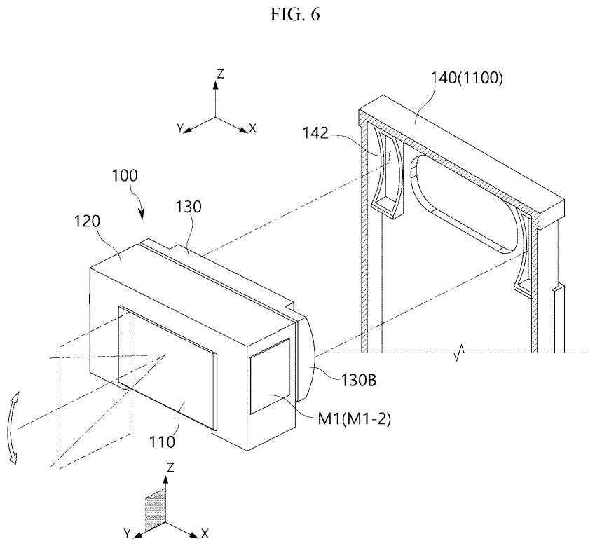

Based on the actuator 100 according to an embodiment of the present disclosure, as will be explained later, the XZ plane or a corresponding plane becomes a plane direction (see FIG. 5) in which the carrier 120 rotates with the middle guide 130 as a relative stator, and the YZ plane becomes a plane direction (see FIG. 6) in which the middle guide 130 of the present disclosure rotates with respect to the housing 140, 1100 together with the carrier 120.

Features of the present disclosure described below correspond to an embodiment that implements the technical idea of the present disclosure. Therefore, within the scope in which the technical idea of the present disclosure is implemented, the middle guide 130 of the present disclosure may be configured to rotate with respect to the XZ plane or the XY plane with the housing 140 as a relative stator, and in a corresponding viewpoint, the carrier 120 of the present disclosure may be configured to rotate on the XY plane or the YZ plane.

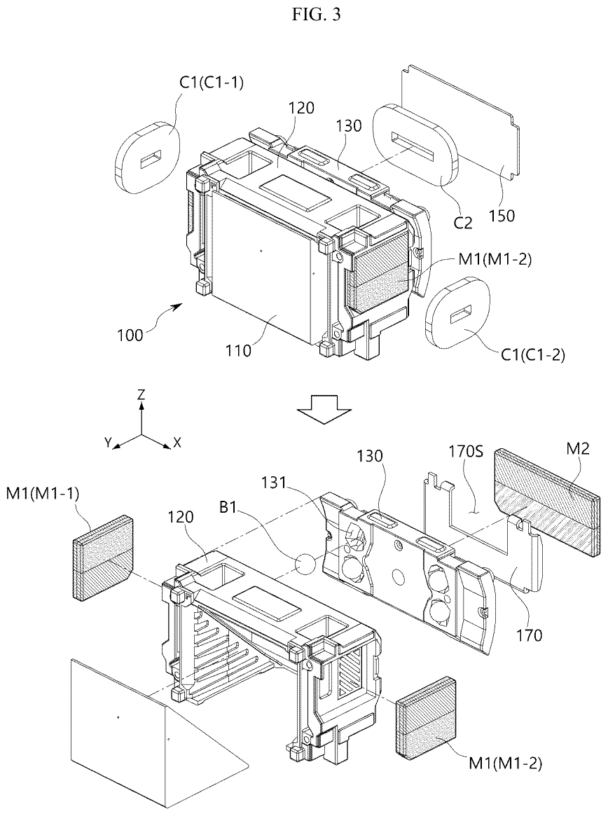

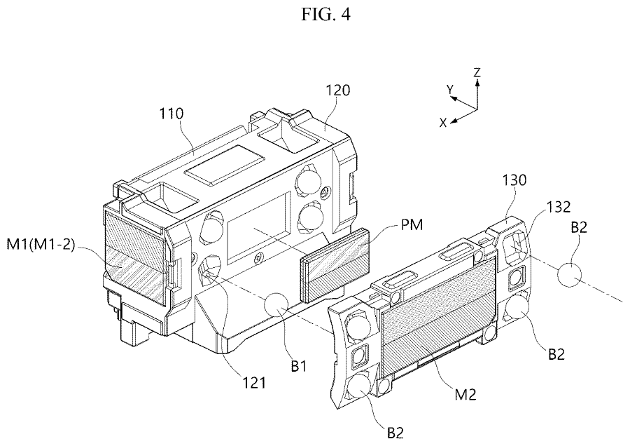

FIGS. 3 and 4 are exploded views showing the detailed configuration of the actuator 100 according to a preferred embodiment of the present disclosure.

As shown in FIG. 3 or the like, the actuator 100 according to an embodiment of the present disclosure may be configured to include a reflector 110, a carrier 120, a middle guide 130, and a housing 140. As described above, the housing 140 of the actuator 100 may be the housing 1100 of the camera module 1000.

First, the overall configuration of the actuator 100 will be described with reference to the drawings, and the detailed configuration and driving relationship of the actuator 100 for OIS operation in each direction will be described later.

As described above, when the light of an object flows into the actuator 100 of the present disclosure along a Z1 path, the reflector 110 of the present disclosure changes (refracting, reflecting, or the like) the path of light to the optical axis direction Z and introduces the light into the lens 50, 60, 70.

The reflector 110 may be one of a mirror or a prism, or a combination thereof, and may be implemented as a variety of members that can change the path of light introduced from the outside to the optical axis direction.

Since the actuator 100 of the present disclosure is configured so that the path of light is refracted by the reflector 110 and then flows into the lens 50, 60, 70, it is not necessary to install the actuator 100 in the thickness direction of a mobile terminal (smartphone or the like). Therefore, even if an optical member having a long physical characteristic in the optical axis direction, such as a zoom lens, is mounted to a portable terminal, the thickness of the portable terminal does not increase, which may give advantageous effects for miniaturization of the portable terminal.

As well known in the art, OIS operation is implemented by moving the lens or the like in a direction that compensates for shaking caused by hand tremor. However, in the embodiment to which the present disclosure is applied, unlike the method of reverse-moving the lens or the like, OIS operation is implemented by moving the reflector 110.

The reflector 110 of the present disclosure is installed at the actuator 100 in a direction in which light enters, namely in a direction toward the front surface in the Y-axis direction, and is fixed to the carrier 120 to physically move together with the carrier 120.

If the carrier 120 of the present disclosure makes rotational movement (based on the XZ plane) based on the middle guide 130 (as a relative stator) or the middle guide 130 of the present disclosure makes rotational movement (based on the YZ plane) based on the housing 140 (as a relative stator) together with the carrier 120, the reflector 110 installed at the carrier 120 also rotates in the same direction.

Preferably, a first ball B1 may be placed between the carrier 120 and the middle guide 130, and a second ball B2 may be placed between the middle guide 130 and the housing 140.

When the balls B1, B2 are interposed, the moving element may linearly move more stably due to minimized friction by the balls' rolling, moving, rotation, and point-contact to the facing object, and has the advantage of reducing noise, minimizing the driving force, and improving the driving precision.

As will be explained later, when the carrier 120 at which the reflector 110 is installed makes rotational movement based on the XZ plane with the middle guide 130 as a relative stator (see FIG. 5), the path of light flowing into the image sensor 30 moves to the X-axis direction due to the rotational movement of the reflector 110, and correct the hand tremor in the X-axis direction.

In addition, when the carrier 120 at which the reflector 110 is installed rotates based on the YZ plane together with the middle guide 130 (see FIG. 6), the path of light flowing into the image sensor 30 moves to the Y-axis direction due to the rotational movement of the reflector 110, and correct the hand tremor in the Y-axis direction.

In the following description, the direction in which the reflector 110 makes rotational movement on the plane corresponding to the XZ plane in relation to the image stabilization in the X-axis direction is referred to as a ‘first direction’, and the direction in which the reflector 110 makes rotational movement on the plane corresponding to the YZ plane in relation to the image stabilization in the Y-axis direction is referred to as a ‘second direction’.

In this respect, the middle guide 130 of the present disclosure corresponds to a stator in a relative relationship with the carrier 120 for the first direction rotational movement, but corresponds to a moving element in a relative relationship with the housing 140 for the second direction rotational movement.

As shown in FIGS. 3 and 4, a second magnet M2 for driving OIS in the second direction may be installed on the middle guide 130.

According to an embodiment, the second magnet M2 may be installed on the middle guide 130 in a state where a back yoke 170 is interposed therebetween to prevent leakage of magnetic force and to concentrate the magnetic force so as to strengthen the magnetic force between the second coil C2 and the second magnet M2.

The magnetic body PM of the present disclosure is configured to be installed on the carrier 120, and is installed to face the second magnet M2 as illustrated in the drawings. Based on FIG. 4, the magnetic body PM is installed on the rear surface (based on the Y-axis) of the carrier 120, and based on the middle guide 130, the magnetic body PM is disposed at the front (based on the Y-axis) of the middle guide 130.

The magnetic body PM generates an attractive force on the second magnet M2 to cause the carrier 120 equipped with the magnetic body PM to come into close contact with the middle guide 130. In this respect, the magnetic body PM may be made of a magnetic material, etc.

It is preferable that the magnetic body PM is made of a magnet so that when the operation of the first direction OIS is terminated since the magnetic force acts as a rotational torque in relation to the second magnet M2, the carrier 120 may be restored to the original reference position. Hereinafter, the magnetic body made of a magnet is referred to as a ‘pulling magnet’ PM.

It is preferable that the magnetic pole of the pulling magnet PM facing the second magnet M2 (hereinafter, referred to as a ‘facing magnetic pole’) is configured to have a polarity opposite to that of the magnetic pole of the second magnet M2 facing the pulling magnet PM (hereinafter, referred to as a ‘counter magnetic pole’).

The pulling magnet PM generates an attractive force on the second magnet M2, so that the carrier 120 equipped with the pulling magnet PM comes into close contact with the middle guide 130.

Since the second magnet M2 is installed on the middle guide 130 and the pulling magnet PM is installed on the carrier 120, if an attractive force is generated between the pulling magnet PM and the second magnet M2, the carrier 120 is pulled toward the middle guide 130, so the carrier 120 and the middle guide 130 between which the first ball B1 is interposed are brought into close contact.

By means of this attractive force, point contact may be continuously maintained between the first ball B1 and the carrier 120, as well as between the first ball B1 and the middle guide 130.

In addition, even if the carrier 120 rotates based on the XZ plane due to the driving of the first direction OIS, if the OIS driving, etc. is terminated or stopped, the pulling magnet PM restores the position or posture of the carrier 120 to a position or posture in which the second magnet M2 and the pulling magnet PM are aligned or correctly arranged to face each other.

For reference, if the actuator 100 of the present disclosure is implemented as an embodiment of driving OIS only in the first direction, the second magnet M2 may be provided to a stator such as the housing 140 rather than a moving body.

Hereinafter, the detailed configuration and driving relationship of the actuator 100 for OIS driving in each direction will be described with reference to FIGS. 5 and 6.

As shown in the drawings, a first magnet M1 for OIS operation in the first direction is installed at the carrier 120 where the reflector 110 is installed.

The first magnet M1 may be installed at the left and right sides of the carrier 120, respectively, as illustrated in the drawings (M1-1, M1-2) in order to improve the driving efficiency. One of the first magnets M1 is referred to as a first sub-magnet M1-1, and the other is referred to as a second sub-magnet M1-2.

A first coil C1 facing the first magnet M1 is installed in the housing 140. When a plurality of first magnets M1 are installed, the first coil C1 may also be installed in plurality (C1-1, C1-2).

When power of an appropriate magnitude and direction is applied to the first coil C1 through the control of an operation driver (not shown) to generate a magnetic force (electromagnetic force) between the first coil C1 and the first magnet M1, the carrier 120 rotates through the guiding of the first ball B1 in a state of facing the middle guide 130 (plane to plane) (see FIG. 5), and the X-axis direction OIS, i.e., the first direction OIS, is implemented by this rotational movement. In this case, the rotary axis RA for the first direction OIS corresponds to the Y-axis.

The first ball B1 may be disposed between the carrier 120 and the middle guide 130. Specifically, the first ball B1 may be disposed between the first rail 121 provided on the carrier 120 and the first rail 131 provided on the middle guide 130.

In order to effectively guide the rotational movement, the first rail 121, 131 may have a rounded shape (e.g., a track shape, etc.), and in order to effectively guide the rotational movement, it is preferable that the first ball B1 is configured to be partially received in at least one of the first rails 121, 131.

Although the drawing shows an embodiment in which the first rails 121, 131 are provided on both the carrier 120 and the middle guide 130, the first rails may be provided on only one of them depending on the embodiment. In this case, the component on which the first rail is not provided may have a groove or format portion that accommodates the first ball B1 and prevents the first ball B1 from being separated externally.

Depending on the embodiment, a detection sensor may be further included. In this case, when the detection sensor detects the position of the carrier 120 (specifically, the first magnet M1 or the sensing magnet installed at the carrier 120, or the like) and transmits the corresponding signal to the operation driver, the operation driver controls power of the corresponding magnitude and direction to be applied to the first coil C1.

The detection sensor may be implemented as a Hall sensor that detects the change in magnitude and direction of the magnetic field of a magnet present within the detection area using the Hall effect and outputs an electrical signal accordingly.

From a corresponding point of view, when power of appropriate magnitude and direction is applied to the second coil C2 through control of the operation driver (not shown), a magnetic force (electromagnetic force) is generated between the second coil C2 and the second magnet M2, and the middle guide 130 makes rotational movement in the second direction (YZ plane) based on the housing 140 (as a relative stator) together with the carrier 120 using the generated magnetic force as a driving force (see FIG. 6).

The second rails 132, 142 are provided on the rear surface 130B (based on the Y-axis) of the middle guide 130 and the front surface (based on the Y-axis) of the housing 140, and the second ball B2 is disposed between the second rails 132, 142.

If a magnetic force is generated between the second coil C2 and the second magnet M2, the middle guide 130 rotates (rotates in the second direction) along the round shape of the second rails 132, 142 between which the second ball B2 is interposed.

The yoke plate 150 is provided on the housing 140, which functions as a relative stator for the second direction movement of the middle guide 130, and generates an attractive force with the second magnet M2 installed on the middle guide 130.

By the attractive force between the yoke plate 150 and the second magnet M2, point contact between the middle guide 130 and the second ball and between the second ball B2 and the housing 140 may be continuously maintained.

If the first direction rotational movement is driven, the middle guide 130 of the present disclosure functions as a stator in a relative relationship with the carrier 120 and supports the first direction rotational movement of the carrier 120. In addition, when the second direction rotational movement is driven, the housing 140 of the present disclosure functions as a stator in a relative relationship with the middle guide 130 and supports the second direction rotational movement of the middle guide 130.

The first rail 131 formed on the middle guide 130 may have a rounded shape like a track based on the XZ plane, as illustrated in the drawings, to guide the first direction rotational movement of the carrier 120. The second rail 132 may be formed in a rounded shape based on the YZ plane to guide the second direction rotational movement of the middle guide 130 along with the carrier 120.

Since the first rail 131 and the second rail 132 are formed in directions perpendicular to each other, and the second ball B2 is placed to be accommodated between the second rails 132, 142, when the carrier 120 rotates in the first direction with the middle guide 130 as a relative stator through the guiding of the first rail 121, 131 or the like, the second rail 132, 142, the second ball B2, and the like function as physical structures that suppress the rotational movement of the middle guide 130.

Due to this structural relationship, even if a magnetic force (electromagnetic force) is generated between the first magnet M1 and the first coil C1, the middle guide 130 may maintain a fixed position in relation to the housing 140.

From a corresponding point of view, when a driving force is generated at the second magnet M2 due to the magnetic force between the second magnet M2 and the second coil C2, the middle guide 130 makes rotational movement in the second direction (YZ plane) through the guidance of the second rail 132, 142, the second ball B2 interposed therebetween, or the like.

In this case, since the carrier 120 maintains a fixed position in relation to the middle guide 130 due to the restraining structure by the first rail 121, 131 and the first ball B1, the carrier 120 makes rotational movement in the second direction together with the middle guide 130.

The first coil C1, the second coil C2, the Hall sensor, the operation driver, and the like may be mounted to a circuit board 1200 installed at the camera module 1000 or a circuit board provided in the actuator 100 itself. The circuit board 1200 is preferably configured so that a part thereof is exposed to the outside for interfacing with external modules, power supplies, external devices, or the like.

The first rails 121, 131, together with the first balls B1, perform the function of guiding while physically supporting the rotation of the carrier 120, which rotates with the middle guide 130 as a relative stator.

Therefore, if the pulling magnet PM is positioned at the center of the rear surface of the carrier 120 and the first rail 121 is provided at the outer side of the pulling magnet PM, the tilt or gap of the carrier 120 is minimized, and also the first direction rotation of the carrier 120 may be made more stably.

As described above, the plane along which the carrier 120 or/and the middle guide 130 rotates may differ from the form illustrated in the drawing depending on the embodiment.

From a corresponding viewpoint, the direction formed by the plane on which the first rail 121, 131 or the second rail 132, 142 for guiding the rotation of the carrier 120 or the middle guide 130 is provided or formed by the round shape of the rails may differ from the form illustrated in the drawing depending on the embodiment.

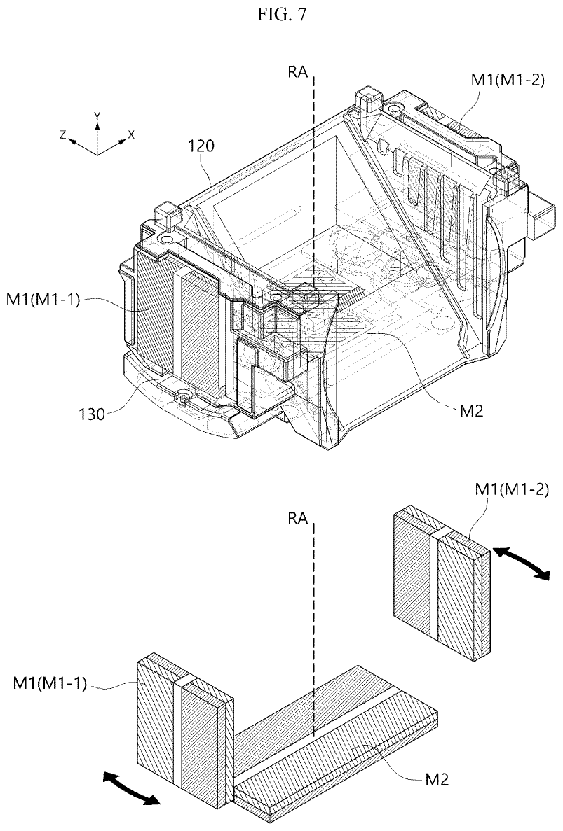

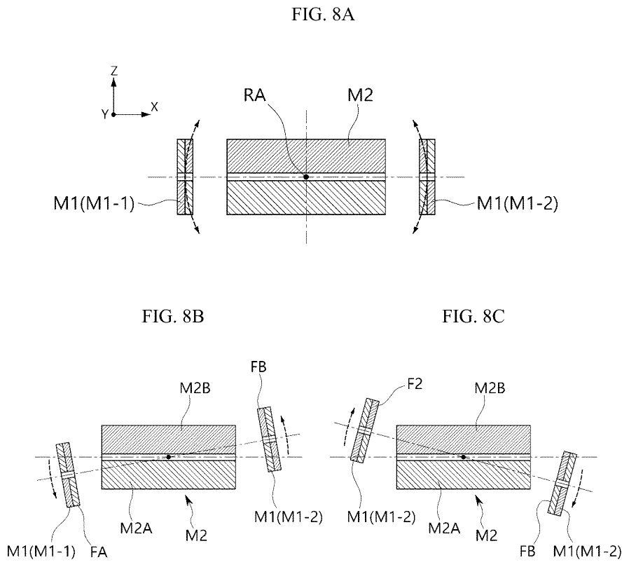

FIG. 7 is a drawing for illustrating the arrangement relationship of individual magnets M1, M2, and FIGS. 8A to 8C are drawings for illustrating the positional relationship of magnets M1, M2 according to the rotation of the carrier 120.

The carrier 120 of the present disclosure is equipped with a reflector 110 and rotates in the first direction (XZ plane) with the middle guide 130 as a relative stator based on the rotary axis RA corresponding to the Y-axis. The rotational movement of the carrier 120 is achieved by the driving force between the first coil C1 and the first magnet M1 as described above.

If the carrier 120 rotates, the first magnet M1 mounted on the carrier 120 also rotates in the same manner. The same applies when the first magnet M1 is composed of first and second sub-magnets M1-1, M1-2 as illustrated in the drawing.

From a relative perspective, the middle guide 130 of the present disclosure functions as a relative stator that physically supports the movement of the carrier 120 when the carrier 120 rotates in the first direction, and rotates together with the carrier 120 in the second direction when the Y-axis OIS is implemented by the second direction rotation.

The first magnet M1 for driving the first direction rotation is installed on the carrier 120, and the second magnet M2 for driving the second direction rotation is installed on the middle guide 130. That is, the first and second magnets M1, M2 are installed in different independent objects.

If the first direction OIS is driven, the carrier 120 rotates in the first direction, and the middle guide 130, which functions as a relative stator for this first direction rotation, does not move.

Therefore, if the first direction OIS is driven, the first sub-magnet M1-1 and the second sub-magnet M1-2 mounted on the carrier 120 rotate in the clockwise direction or counterclockwise direction based on the rotary axis RA as illustrated in FIGS. 7 and 8, and the second magnet M2 mounted on the middle guide 130 maintains its position.

If the second direction OIS is driven, the middle guide 130 and the carrier 120 move together as described above. Therefore, if both the first and second direction OIS are driven, the carrier 120 has a combined displacement due to both the first direction OIS and the second direction OIS with respect to the stator (e.g., the housing (140, 1100)).

If the carrier 120 rotates in the counterclockwise direction by driving the first direction OIS (FIG. 8B), one of the magnetic poles of the first sub-magnet M1-1 becomes relatively close to one of the magnetic poles of the second magnet M2.

Since the second sub-magnet M1-2 rotates in the same direction as the first sub-magnet M1-1, one of the magnetic poles of the second sub-magnet M1-2 also becomes relatively close to one of the magnetic poles of the second magnet M2.

In FIG. 8B, the magnetic pole marked as FA among the magnetic poles of the first sub-magnet M1-1 and the magnetic pole marked as FB among the magnetic poles of the second sub-magnet M1-2 become neighboring magnetic poles.

If the magnetic pole M2A located below (based on FIG. 8A) among the magnetic poles of the second magnet M2 is formed with the same magnetic pole as the neighboring magnetic pole FA of the first sub-magnet M1-1 and the magnetic pole M2B located above (based on FIG. 8A) among the magnetic poles of the second magnet M2 is formed with the same magnetic pole as the neighboring magnetic pole FB of the second sub-magnet M1-2, a repulsive force may be applied between the first and second magnets M1, M2.

This also corresponds to the case where the carrier 120 rotates in the clockwise direction by driving the first direction OIS (FIG. 8C).

If the neighboring magnetic poles of the first and second magnets M1, M2 are formed with the same magnetic pole as above, when the carrier 120 rotates by the first direction OIS, a repulsive force may be applied between the first and second magnets M1, M2 regardless of the rotation direction.

If a repulsive force is applied between the first magnet M1 and the second magnet M2 as above, the driving force required for the first direction rotational movement must increase, so the driving efficiency may be somewhat reduced.

However, since the repulsive force between the first and second magnets M1 and M2 acts as a component that impedes the rotation, this may be easily resolved by increasing the driving force for the first direction rotation so that this impeding component is offset. In addition, according to the simulation and experimental results, the increased driving force profile has relatively linear characteristics, which has significant advantages in the design of logic or algorithms for drive control.

Meanwhile, if an attractive force is generated between the first and second magnets M1, M2, the driving force for first direction rotation may be reduced somewhat.

However, if an attractive force acts between the first and second magnets M1, M2, this attractive force acts in a direction that accelerates the first direction rotation, and this attractive force acts nonlinearly depending on the position of the carrier 120, so the precision of position detection and feedback control by a Hall sensor, etc. is reduced, and due to this problem, the logic or algorithm design for drive control becomes considerably complicated.

In addition, since a repulsive force is applied between the first magnet M1 and the second magnet M2, a force is applied in a direction opposite to the rotational direction by the driving of the first direction OIS. Thus, if the first direction OIS is terminated, this force may function as a restoring force to return the carrier 120 to the original reference position, thereby further improving the efficiency of returning the carrier 120 to the reference position.

As illustrated in the drawings, the carrier 120 may be configured such that the first sub-magnet M1-1 is provided at one side thereof, and the second sub-magnet M1-2, which rotates in the same direction as the first sub-magnet M1-1 when the carrier 120 rotates in the first direction, is provided at the other side thereof.

According to this embodiment of the present disclosure, when the first direction OIS is terminated, the force to rotate the carrier 120 to the original position is applied symmetrically and distributedly, so that the carrier 120 may be returned to the reference position more stably.

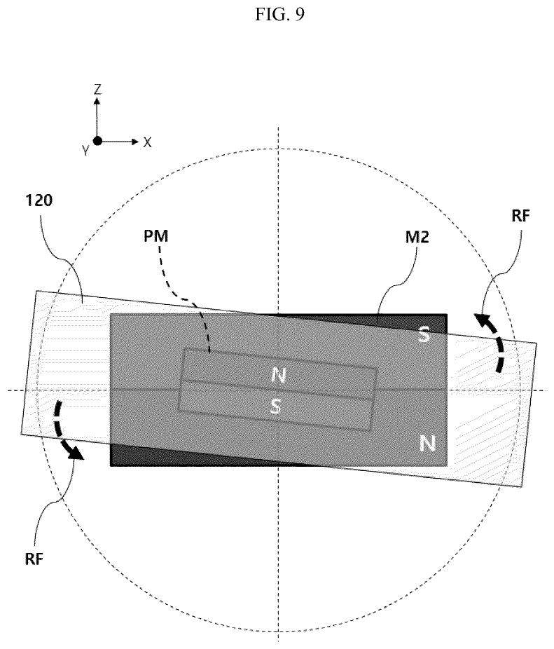

FIG. 9 is a drawing for illustrating the operational relationship of a pulling magnet PM according to an embodiment of the present disclosure.

If power of appropriate magnitude and direction is applied to the first coil C1 as described above, the carrier 120 rotates in the first direction by the magnetic force between the first coil C1 and the first magnet M1, and the shaking in the X-axis direction is corrected by this rotation.

In this way, if the carrier 120 rotates, the pulling magnet PM installed on the carrier 120 also moves together with the carrier 120, so the mutual positional (posture) relationship between the pulling magnet PM and the second magnet M2 changes from alignment to misalignment.

In this state, if an event such as termination or stop of the operation of the first direction OIS occurs, the attractive and repulsive forces between the facing magnetic pole of the pulling magnet PM and the counter magnetic pole of the second magnet M2 function as a return force that naturally returns the pulling magnet PM to the reference position (default position), which is the position or posture in which the pulling magnet PM and the second magnet M2 are aligned.

FIG. 9 illustrates an example of the return force (RF) by which the carrier 120 equipped with the pulling magnet PM rotates in the counterclockwise direction, on the assumption that the drive is terminated in a state where the carrier 120 is rotated in the clockwise direction by the first direction OIS.

Since the return force for the carrier 120 to return to the reference position is a rotational force, it is desirable that the pulling magnet PM has a shape that extends in a direction corresponding to the longitudinal direction of the second magnet M2, for example, the longitudinal direction in which the magnetic pole boundary of the second magnet M2 extends, so that the carrier 120 may return to the reference position with minimized torque.

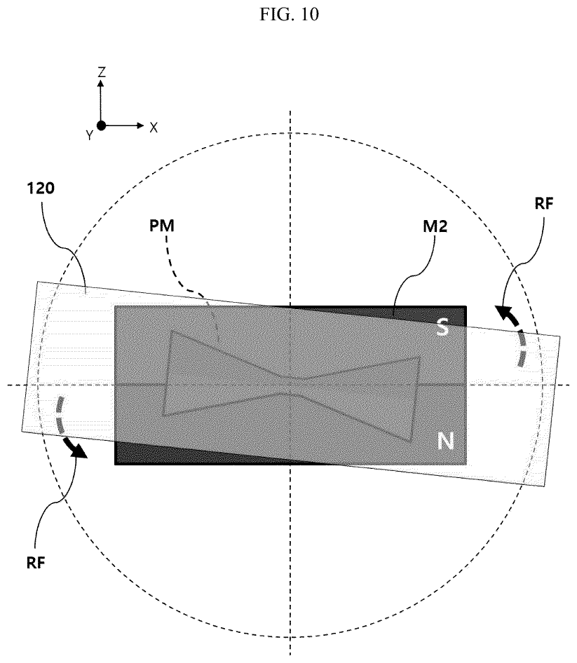

In addition, the torque is proportional to the distance from the center of rotation and the force applied, and the magnetic force is proportional to the magnetic flux density. Therefore, in order to provide sufficient adhesion between the carrier 120 and the middle guide 130 and at the same time improve the efficiency of the rotational return force, as shown in FIG. 10, it is preferable that the pulling magnet PM is configured to have an outer width larger than the inner width based on the surface facing the second magnet M2.

If the pulling magnet PM may be configured to have an outer width larger than the inner width, shapes having an overall diagonal shape as exemplified in FIGS. 8A-8C or shapes having a stepped shape may be applied.

Meanwhile, as explained with reference to FIG. 3, etc., the back yoke 170 made of a magnetic material for magnetic force concentration, etc. is installed on the middle guide 130 by insert injection, etc., and the second magnet M2 is installed in an opposite direction toward the second coil C2.

Therefore, because the back yoke 170 is located between the pulling magnet PM and the second magnet M2 and is made of a magnetic material, it is possible to reduce the suction force and return force (return force to return to the reference position) between the pulling magnet PM and the second magnet M2.

In order to effectively resolve this problem, as illustrated in FIG. 3, it is preferable that the back yoke 170 is configured to have an open portion 170S in an area or region corresponding to the area where the second magnet M2 and the pulling magnet PM face each other.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An actuator for a reflector, comprising:
a carrier at which a reflector is installed, the carrier configured to rotate in a first direction;
a middle guide at which a second magnet is installed, the middle guide configured to support rotation of the carrier;
a first ball disposed between the carrier and the middle guide;
a first magnet installed on the carrier; and
a first coil configured to provide a driving force to the first magnet,
wherein neighboring magnetic poles of the first and second magnets are the same magnetic pole so that a repulsive force acts between the first and second magnets.

2. The actuator for a reflector according to claim 1, further comprising:
a housing configured to support rotation of the middle guide in a second direction;
a second ball disposed between the middle guide and the housing; and
a second coil configured to provide a driving force to the second magnet.

3. The actuator for a reflector according to claim 1,
wherein the first magnet includes:
a first sub-magnet provided at one side of the carrier; and
a second sub-magnet provided at the other side of the carrier and configured to rotate in the same direction as the first sub-magnet when the carrier rotates in the first direction,
wherein when the carrier rotates in the first direction, a magnetic pole of the first sub-magnet close to the second magnet is opposite to a magnetic pole of the second sub-magnet close to the second magnet.

4. The actuator for a reflector according to claim 1, further comprising:
a magnetic body installed on the carrier and configured to generate an attractive force with the second magnet.

5. The actuator for a reflector according to claim 4,
wherein the magnetic body is a magnet facing the second magnet, and
wherein a facing magnetic pole of the magnetic body facing the second magnet is opposite to a magnetic pole of the second magnet.

6. The actuator for a reflector according to claim 5,
wherein the magnetic body has a shape extending in a direction corresponding to a longitudinal direction of the second magnet.

7. The actuator for a reflector according to claim 5,
wherein the magnetic body has an outer width greater than an inner width.
